(19) United States
(12) Patent Application Publication
(10) Pub. No.: US 2025/0320992 A1
(43) Pub. Date: Oct. 16, 2025

(54) LAMP BRACKET WIRE CLIP STRUCTURE AND LAMP BRACKET

(71) Applicant: TILTA INC., Burbank, CA (US)

(72) Inventors: Yaxiong YAN, Shenzhen (CN); Sen WU, Shenzhen (CN); Wenping ZENG, Shenzhen (CN); Kefeng ZHOU, Shenzhen (CN)

(21) Appl. No.: 18/787,584

(22) Filed: Jul. 29, 2024

(30) Foreign Application Priority Data
Apr. 12, 2024 (CN) 2024207695852

(51) Int. Cl. F21V 23/00; F21V 19/02; F21V 33/00

(52) U.S. Cl. CPC F21V 23/001; F21V 19/02; F21V 33/0052

(57) ABSTRACT

The present disclosure pertains to the field of lamp brackets, specifically a lamp bracket wire clip structure and lamp bracket. The lamp bracket wire clip structure includes a carrier equipped with a storage groove, and a wire clip featuring a wire hole designed for the passage of electric wires. The wire clip, hinged within the storage groove, can be stored within or rotated out of the storage groove. The wire clip facilitates the passage of electric wires through the wire hole of the wire clip, enabling connection to corresponding electrical equipment. The wire clip guides the wires and effectively prevents tangling, thereby avoiding any potential disruption to the normal operation of other structures. When there is no need for wires to pass through, the clip can be rotated and neatly tucked away into the storage groove.

### CROSS-REFERENCE TO RELATED APPLICATIONS

The present application for patent claims priority to and the benefit of pending Chinese Application No. 2024207695852, filed Apr. 12, 2024, and hereby expressly incorporated by reference herein as if fully set forth below in its entirety and for all applicable purposes.

### TECHNICAL FIELD

The present disclosure pertains to the field of lamp brackets, specifically a lamp bracket wire clip structure and lamp bracket.

### INTRODUCTION

During photography, various factors influence the photographic effect, with lighting being a crucial determinant of the final output.

Photographers often employ auxiliary equipment to achieve their desired effects. For instance, they may mount lights on lamp brackets and use motors on these brackets to adjust the lights' position, thereby controlling the lighting effect and enhancing the photography results. However, since lights require electric wires for power, adjusting their position can lead to wire moving and tangling. This tangling can exert a reaction force on the lights, potentially affecting motor operation and, in extreme cases, causing motor damage.

### BRIEF SUMMARY

To solve the aforementioned challenges, one objective of the present disclosure is to introduce a lamp bracket wire clip structure capable of securely clamping electric wires, thereby preventing any interference with the normal operation of other structures.

Furthermore, another objective of this disclosure provides a lamp bracket that ensures electric wires are contained, preventing them from disrupting the regular function of motors during lighting adjustments and subsequently avoiding any motor damage.

To realize these objectives, the technical approach adopted in the present disclosure is detailed below.

A lamp bracket wire clip structure, comprising:

A carrier equipped with a storage groove; and

a wire clip featuring a wire hole designed for passing electric wires. The wire clip,

hinged within the storage groove, allows for storage within or rotation out of the storage groove.

This lamp bracket wire clip structure facilitates the passage of electric wires through the wire hole of the clip, enabling connection to corresponding electrical equipment. This guides the wires and effectively prevents tangling, thereby avoiding any potential disruption to the normal operation of other structures. When there is no need for wires to pass through, the clip can be rotated and neatly tucked away into the storage groove.

A lamp bracket, wherein a light mounting component and the lamp bracket wire clip structure are included. The light mounting component horizontally features a light mounting position for mounting lights, and the wire clip's wire hole is horizontally aligned.

The lamp bracket allows for the passage of electric wires through the wire hole of the clip, enabling connection to corresponding electrical equipment. This guides the wires and effectively prevents tangling, thereby avoiding any potential disruption to the normal operation of other structures. Given the horizontal configuration of the light mounting position and the wire hole, the electric wire threaded through the latter is horizontally inserted into the light socket at the mounting position. This ensures that when the light undergoes pitch or yaw rotation, the electric wire effortlessly follows this movement, significantly reducing the chance of the wire disconnecting from the light.

The benefit of this present disclosure lies in the passage of electric wires through the wire hole of the clip, enabling connection to corresponding electrical equipment. This guides the wires and effectively prevents tangling, thereby avoiding any potential disruption to the normal operation of other structures. When there is no need for wires to pass through, the clip can be rotated and neatly tucked away into the storage groove.

### BRIEF DESCRIPTION OF THE DRAWINGS

FIG. 1 is a diagram of a lamp bracket from a first perspective according to some aspects of the disclosure.

FIG. 2 is a diagram of the lamp bracket from a second perspective.

FIG. 3 is a diagram of a wire clip according to some aspects of the disclosure.

FIG. 4 is a diagram of the lamp bracket with the wire clip hidden.

FIG. 5 is a diagram depicting the path of an electric wire on the lamp bracket.

### REFERENCE NUMERALS

1. Carrier; 11. Storage groove; 12. Limiting part; 13. Hinged protrusion; 14. Hinge;

2. Wire clip; 21. Wire hole; 22. Rotating part; 23. Clamping part; 231. First clamping part; 2311. First mounting groove; 232. Second clamping part; 2321. Second mounting groove; 24. locking component; 241. First locking part; 242. Second locking part;

3. Light mounting component; 31. light mounting position;

4. Electric wire.

### DETAILED DESCRIPTION

To further clarify the objectives, technical solutions, and aspects of the present disclosure, the following provides a comprehensive description, accompanied by drawings and practical examples. It is important to note that the specific embodiments discussed here serve to illustrate the invention and do not limit its scope.

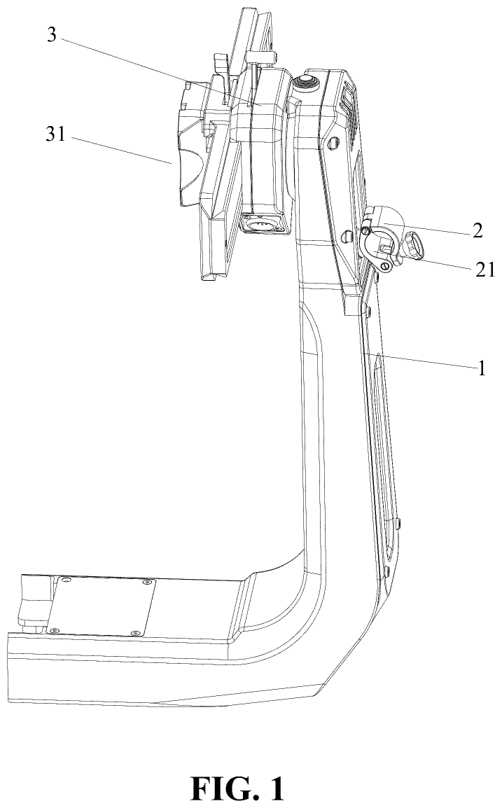

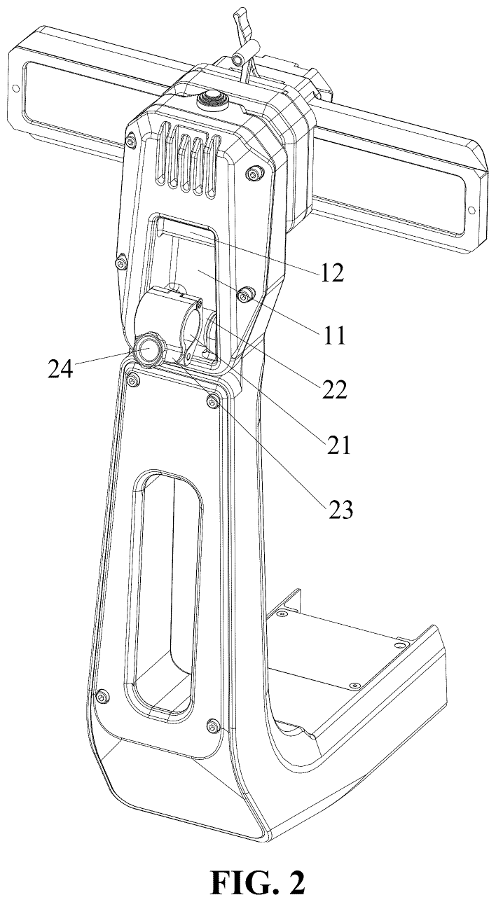

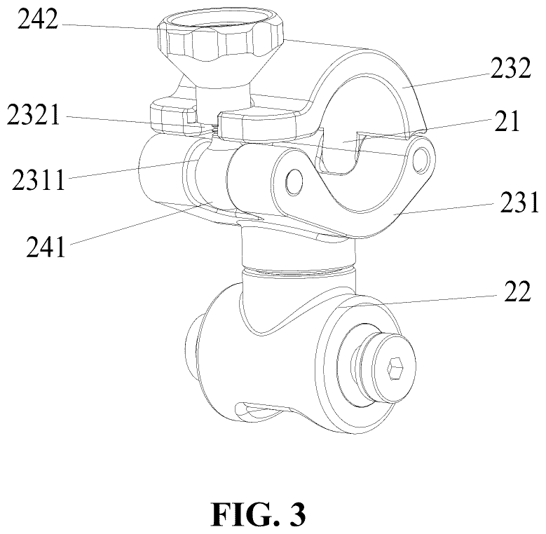

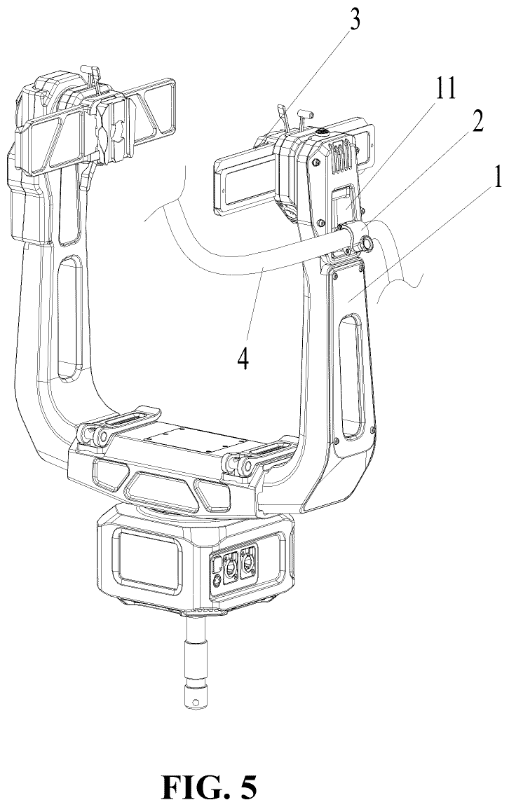

Referring to FIGS. 1-5, aspects of the present disclosure provide a lamp bracket wire clip structure that includes a carrier 1 equipped with a storage groove 11, and a wire clip 2 featuring a wire hole 21 designed for the passage of electric wires 4. The wire clip 2 is hinged within the storage groove 11. For example, the wire clip 2 can pivot or rotate relative to the storage groove 11. In its inactive state, the wire clip 2 can be rotated and neatly tucked into the storage groove 11 of the lamp bracket. When needed, the wire clip 2 can be easily rotated out of the storage groove 11, allowing electric wires 4 to be threaded through the wire hole 21 and connected to the appropriate electrical components. This arrangement not only organizes the wires 4 but also ensures they can adapt to the movement of the lights, thereby preventing tangles and ensuring normal operation of other structures.

In some aspects, the wire clip 2 includes a rotating part 22 and a clamping part 23. The rotating part 22 is hinged within the storage groove 11, while the clamping part 23 is fixedly connected to the rotating part 22. The clamping part 23 features a wire hole 21 and corresponds to the storage groove 11. The rotation of the rotating part 22 relative to the storage groove 11 facilitates the smooth rotation of the clamping part 23 into and out of the storage groove 11.

In some aspects, a limiting part 12, which aligns with the clamping part 23, is situated within the storage groove 11, limiting the clamping part's position when the clamping part 23 is stored within the storage groove 11. This design ensures case of retrieval when needed.

In some aspects, the clamping part 23 includes a first clamping part 231 and a second clamping part 232. The first clamping part 231 is affixed to the rotating part 22, with a first end hinged to a first end of the second clamping part 232. A locking component 24, located between second ends of both the first clamping part 231 and the second clamping part 232, controls locking and unlocking of the first clamping part 231 and the second clamping part 232. The wire hole 21 is positioned between the first and second clamping parts 231 and 232.

When the wire clip 2 is operated from within the storage groove 11, controlling the locking component 24 releases the second ends of both the first clamping part 231 and the second clamping part 232. This enables the first ends of the clamping parts 231 and 232 to rotate relatively, opening the wire hole 21. The electric wire 4 is then placed between the first and second clamping parts 231 and 232. Afterward, by controlling the relative rotation of the first ends of the clamping parts, the wire clip 2 is closed. Finally, by once again controlling the locking component 24, the second ends of the clamping parts 231 and 232 are secured, completing the installation of the electric wire 4.

In some aspects, the locking component 24 includes a first locking part 241 and a second locking part 242. The first clamping part 231 has a second end that features a first mounting groove 2311, while the second clamping part 232 has a second end that features a second mounting groove 2321. The first locking part 241 has a first end that is hinged in the first mounting groove 2311, and the first locking part 241 has a second end that aligns with the second mounting groove 2321. The second locking part 242, which is movable at the second end of the first locking part 241, corresponds to the second end of the second clamping part 232.

When the clamping parts 231 and 232 are in the closed position, the first end of the first locking part 241 is capable of rotating within the first mounting groove 2311. This rotation enables the second end of the first locking part 241 to shift into the second mounting groove 2321. Then, the second locking part 242 is adjusted until it firmly contacts the second end of the second clamping part 232. This action locks the second ends of both clamping parts 231 and 232 together, due to the coordinated movement of the first and second locking parts 241 and 242.

In some aspects, the second locking part 242 is moveably connected to the second end of the first locking part 241 via threading (e.g., featuring a bolt and a nut).

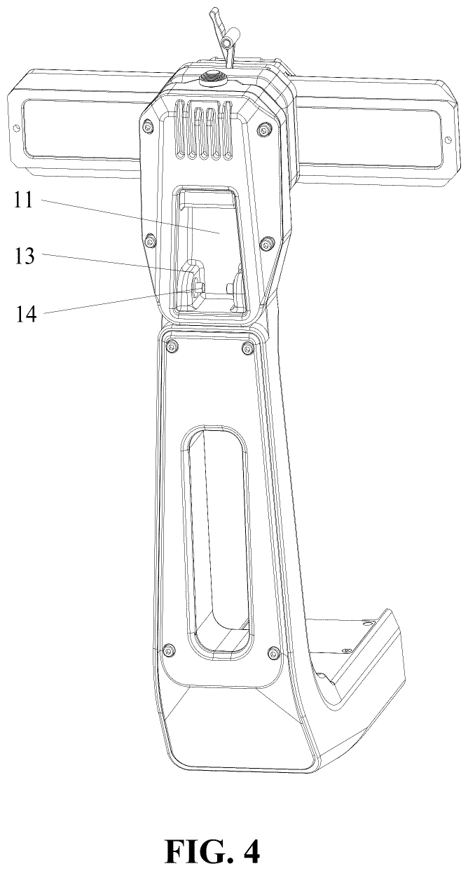

Referring to FIG. 4, in some aspects, hinged protrusions 13 are present on both sides (e.g., opposing sides) of the storage groove 11. The ends of the rotating part 22 are rotatably connected to the two hinged protrusions 13.

In some aspects, a hinge 14 is situated within each hinged protrusion 13. An end of the hinge 14 penetrates the hinged protrusion 13 and is exposed within the storage groove 11. The ends of the hinges 14 on both hinged protrusions 13 are rotatably linked to the ends of the rotating part 22.

In some aspects, the hinge 14 can take the form of a locking bolt.

Referring to FIGS. 1-5, a light mounting component 3 and the lamp bracket wire clip structure are included in this lamp bracket. The light mounting component 3 horizontally features a light mounting position 31 for mounting lights, and the wire hole 21 of the wire clip 2 is horizontally aligned.

The wire clip 2 is positioned horizontally to ensure that the wire hole 21 guides the electric wire 4 to pass through horizontally. This configuration allows this end of the electric wire 4 to adapt and follow the lamp's pitching rotation, thereby preventing any twisting of the electric wire 4 during such movements.

Given the horizontal configuration of the light mounting position 31 and the wire hole 21 and a wiring path formed, the electric wire 4 threaded through the wire hole 21 is horizontally inserted into a light socket at the mounting position 31. This ensures that when the light undergoes pitch or yaw rotation, the electric wire 4 effortlessly follows this movement, significantly reducing the chance of the electric wire 4 disconnecting from the light.

In some aspects, the lamp mounting component 3 is movably attached to the carrier 1. A lamp adjusting motor assembly, designed to drive the movement of the lamp mounting component 3, can be positioned between the lamp mounting component 3 and the carrier 1. This motor-driven assembly facilitates pitching or yaw rotation between the lamp mounting component 3 and the carrier 1.

It is important to emphasize that the above description represents an exemplary embodiment of the present invention and does not limit its scope. Any modifications, equivalent substitutions, or improvements that align with the spirit and principles of the present disclosure are considered within its protective scope.

1. A lamp bracket wire clip structure, comprising:
a carrier equipped with a storage groove; and
a wire clip hinged within the storage groove, the wire clip featuring a wire hole configured for passing an electric wire through the wire hole,
wherein the wire clip is rotatably connected to the carrier, rotatable between a first position for storage within the storage groove and a second position out of the storage groove.

2. The lamp bracket wire clip structure according to claim 1, wherein:
the wire clip comprises a rotating part and a clamping part;
the rotating part is hinged within the storage groove, and the clamping part is connected to the rotating part; and
the clamping part features the wire hole.

3. The lamp bracket wire clip structure according to claim 2, wherein the carrier further comprises a limiting part within the storage groove for limiting a position of the clamping part within the storage groove.

4. The lamp bracket wire clip structure according to claim 2, wherein the clamping part comprises a first clamping part and a second clamping part;
the first clamping part is connected to the rotating part, with a first end hinged to a first end of the second clamping part;
further comprising a locking component, located between a second end of the first clamping part and a second end of the second clamping part, the locking component configured to control locking and unlocking of the first clamping part and the second clamping part;
wherein the wire hole is positioned between the first clamping part and the second clamping part.

5. The lamp bracket wire clip structure according to claim 4, wherein the locking component comprises a first locking part and a second locking part;
the second end of the first clamping part comprises a first mounting groove, and the second end of the second clamping part comprises a second mounting groove;
a first end of the first locking part is hinged in the first mounting groove, and a second end of the first locking part aligns with the second mounting groove; and
the second locking part, movable at the second end of the first locking part, corresponds the second end of to the second clamping part.

6. The lamp bracket wire clip structure according to claims claim 2, wherein the carrier further comprises two hinged protrusions respectively on opposite sides of the storage groove; and
two ends of the rotating part are rotatably connected to the two hinged protrusions, respectively.

7. The lamp bracket wire clip structure according to claim 6, wherein each of the two hinged protrusions comprises a hinge;
a first end of the hinge penetrates the hinged protrusion and a second end of the hinge is exposed within the storage groove;
the hinge is rotatably linked to the rotating part.

8. A lamp bracket comprising:
a light mounting component; and
the lamp bracket wire clip structure of claim 1;
wherein the light mounting component comprises a horizontal light mounting position for mounting lights, and the wire hole is horizontally aligned with the light mounting component.

9. The lamp bracket according to claim 8, wherein the wire clip is horizontally arranged, ensuring the wire hole guides electric wires horizontally.

10. The lamp bracket according to claim 8, further comprising:
a light adjustment motor assembly, positioned between the light mounting component and the carrier, configured to at least one of pitch or yaw the light mounting component relative to the carrier, wherein the light mounting component is movably set on the carrier.

11. The lamp bracket wire clip structure according to claim 6, wherein the two hinged protrusions comprise a first hinge and a second hinge, respectively, and the first hinge and the second hinge extend toward each other.
